(19) United States
(12) Patent Application Publication
(10) Pub. No.: US 2010/0298157 A1
(43) Pub. Date: Nov. 25, 2010

(54) PHOSPHOPROTEOMIC EVALUATION OF DIABETES AND OBESITY

(75) Inventors: Emanuel Petricoin, III, Gainesville, VA (US); Valerie Calvert, Arlington, VA (US); Zobair Younossi, Fairfax Station, VA (US); Lance Liotta, Bethesda, MD (US)

Correspondence Address: FOLEY AND LARDNER LLP;SUITE 500, 3000 K STREET NW, WASHINGTON, DC, 20007, US

(73) Assignees: GEORGE MASON INTELLECTUAL PROPERTIES, INC., Fairfax, VA (US); INOVA HEALTH CARE SERVICES, Falls Church, VA (US)

(21) Appl. No.: 12/600,755

(22) PCT Filed: May 19, 2008
(86) PCT No.: PCT/US08/06384

§ 371 Date: Jun. 15, 2010

Related U.S. Application Data
(60) Provisional application No. 60/939,208, filed on May 21, 2007.

(51) Int. Cl. C40B 30/04

(52) U.S. Cl. 506/9

(57) ABSTRACT

A subject's likelihood of responding to bariatric surgery can be assessed by measuring the phosphorylation state of certain proteins found in white adipose tissue (WAT). In particular, measuring the phosphorylation state of particular proteins can predict a patient's likelihood of resolving diabetes mellitus following bariatric surgery. In addition, evaluating the phosphorylation state of certain proteins forecasts a patient's capacity to reduce excess body weight and/or waist size following bariatric surgery. Such tests are valuable tools for managing the diseases of diabetes and obesity and determining who would most likely benefit from bariatric surgical procedures such as gastic bypass surgery.

This application claims the priority benefit of U.S. Provisional Application No. 60/939,208 filed on May 21, 2007, which is hereby incorporated herein by reference.

### BACKGROUND

Central adiposity is associated with insulin resistance (IR), diabetes mellitus (DM) and non-alcoholic fatty liver disease (NAFLD) (1-3). Diabetics with NAFLD are at risk for progressive liver disease. After weight loss, however, some obese diabetics completely resolve their DM. Adipocytes, and specifically white adipose tissue (WAT), may participate in the disease processes as a bioactive organ. Cell signaling pathways within WAT, therefore, may provide clues to pathogenesis of affected organs at a distant site.

Aberrant cell signaling can be seen in WAT from patients with progressive NAFLD versus patients with non-progressive forms of NAFLD (4). The contribution of WAT in the resolution of diabetes may occur through the constellation of secreted adipokines and chemokine paracrine and autocrine cascades and the resulting signal transduction pathway network activations. For example, adipokines, such as visfatin, adiponectin and resistin, are known to be a component of IR and DM (5).

Intracellular signaling pathways within WAT may hold the potential to forecast resolution of DM, metabolic syndrome (IR) and overall weight loss success in patients undergoing bariatric surgery. Such predictive methods would be useful weapons in the battle against diabetes and obesity.

### SUMMARY

In one aspect, a method of assessing whether an obese patient with diabetes mellitus treated with a bariatric surgical procedure possesses a capacity to resolve the diabetes mellitus comprises a) obtaining a biological sample from said patient, b) measuring in the sample the phosphorylation level of pSMAD2 S465/467 or pErbB2 Y1248, and c) correlating the phosphorylation level to a capacity to resolve the diabetes mellitus. In some embodiments, the sample comprises adipose tissue, white adipose tissue, omental fat or subcutaneous fat.

In another aspect, there is provided a method of estimating the likelihood of success of bariatric surgery for a patient comprising a) obtaining a biological sample from said patient; b) measuring the phosphorylation level of a protein in Table 3 or Table 4; and c) correlating said phosphorylation level to a likelihood that said patient will benefit from bariatric surgery. In one embodiment, the method comprises measuring the phosphorylation level of a protein in Table 3 and said benefit is a reduction in excess body weight. In another embodiment, the method involves measuring the phosphorylation level of a protein in Table 4 and said benefit is a reduction in waist size. In some examples, the methods estimate a patient's likelihood to achieve a reduction of more than 50% in excess body weight (EBW) or waist size.

Other objects, features and advantages will become apparent from the following detailed description. The detailed description and specific examples are given for illustration only since various changes and modifications within the spirit and scope of the invention will become apparent to those skilled in the art from this detailed description. Further, the examples demonstrate the principle of the invention and cannot be expected to specifically illustrate the application of this invention to all the examples where it will be obviously useful to those skilled in the prior art.

### BRIEF DESCRIPTION OF THE DRAWINGS

FIG. 1 shows an unsupervised heatmap of WAT obtained from 144 obese patients, 31 with clinically diagnosed DM and 113 who were not DM. WAT was collected at time of bariatric surgery, immediately frozen, and patients were followed for 24 months. Phosphorylated signaling endpoints were measured by reverse phase protein microarray and those that were statistically significant (p<0.05; Table 2) were used.

FIG. 2 schematically shows that statistically significant signaling endpoints that can discriminate obese patients with DM vs. patients without DM, and patients with resolved IR vs. unresolved IR reside within key signaling pathways that control glucose metabolism, insulin signaling, apoptosis and cytokine/growth factor signaling (boxed).

### DETAILED DESCRIPTION

A subject's likelihood of responding to bariatric surgery can be assessed by measuring the phosphorylation state of certain proteins found in white adipose tissue (WAT). In particular, measuring the phosphorylation state of pSMAD2 S465/467 or pErbB2 Y1248 can predict a patient's likelihood of resolving diabetes mellitus following bariatric surgery without pharmaceutical intervention. Meanwhile, evaluating the phosphorylation state of certain proteins forecasts a patient's capacity to reduce excess body weight and/or waist size following bariatric surgery. Such tests are valuable tools for managing the diseases of diabetes and obesity.

Some obese patients with DM undergoing bariatric surgery realize a complete remission of their disease. Such diabetes resolutions can include a reversal of impaired glucose tolerance, a return to a normal fasting glucose level or a return to a normal glycosylated hemoglobin level. Furthermore, such resolutions often are realized without diabetic medications.

In one embodiment, a method of assessing whether an obese patient with diabetes mellitus treated with a bariatric surgical procedure possesses a capacity to resolve the diabetes mellitus comprises a) obtaining a biological sample from said patient, b) measuring in the sample the phosphorylation level of pSMAD2 S465/467 or pErbB2 Y1248, and c) correlating the phosphorylation level to a capacity to resolve the diabetes mellitus. In some aspects, the sample comprises adipose tissue, white adipose tissue, omental fat or subcutaneous fat.

Such methods are useful for gauging the likelihood that bariatric surgery will resolve a patient's diabetes mellitus. In turn, the knowledge supports not only the decision analysis regarding the surgery but also informs post-operative treatment, and in particular the maintenance of diabetic medications.

In post-surgery follow-up, diabetes resolution can be assessed by, for example, measuring glucose tolerance or glycanated hemoglobin (A1C).

In another embodiment, a method of estimating the likelihood of success of bariatric surgery for a patient involves a) obtaining a biological sample from said patient; b) measuring the phosphorylation level of a protein in Table 3 or Table 4; and c) correlating said phosphorylation level to a likelihood that said patient will benefit from bariatric surgery. In one aspect, the method comprises measuring the phosphorylation level of a protein in Table 3 and said benefit is a reduction in excess body weight. In another aspect, the method involves measuring the phosphorylation level of a protein in Table 4 and said benefit is a reduction in waist size. In some examples, the methods estimate a patient's likelihood to achieve a reduction of more than 50% in excess body weight (EBW) or waist size.

A variety of methods for analyzing protein phosphorylation states are known in the art. For example, proteins can be examined in a western analysis using antibodies specific for epitopes containing specific phosphorylation states. In this regard, reverse-phase protein microarrays can be employed. See Liotta et al., Cancer Cell, 3(4):317-325 (2003), which is hereby incorporated by reference.

In another example, a phosphorylation state can be determined by measuring a phosphorylation-driven conformational change on electron transport. In this regard, helix unfolding impacts the rate of electron transport in a dichromomorphic peptide model, resulting in an order of magnitude difference in electron transport. Fox et al., J. Am. Chem. Soc., 119:5277-5285 (1997). A 10-fold difference, for example, in electron transport resulting from the addition of the phosphate group onto the surface of the peptide is likely attributable to a conformational shift within the secondary structure of the peptide. Additionally, phosphorylation may increase the space between atoms within a peptide, and as a result the entire length of a peptide may increase. Phosphorylation states also can be measured by mass spectrometry.

### Example 1

### Sample Collection and Processing

144 patients [age 44+/−13 yrs, 30% male, 73% NAFLD, ALT 32+/−21 IU/L] undergoing bariatric surgery were evaluated. Prior to surgery, 21% of patients had clinically overt DM. Follow-up data including excess weight loss was available for all patients (10.25+/−9.79 months). During the follow-up, 20 diabetics resolved their DM, while 11 continued to progress with the disease unresolved. Protein profiling was performed on 200 mg of WAT, which was snap frozen at the time of surgery.

WAT Processing and Protein Extraction: 200 mg of each adipose tissue sample along with 1.2 ml of Lysis Buffer containing a 1:1 mixture of 2× Tris-Glycine SDS Sample Buffer (Invitrogen Life Technologies, Carlsbad, Calif.) and Tissue Protein Extraction Reagent (Pierce, Rockford, Ill.) plus 2.5% β-mercaptoethanol was transferred to a specialized container (PULSE Tube) and subjected to ten rapid pressure cycles in the Barocycler NEP3299 (Pressure Biosciences, West Bridgewater, Mass.). Each cycle consisted of 20 seconds at 35,000 psi followed by 20 seconds at ambient pressure.

### Example 2

### Evaluation of Phosphorylation Levels of Selected Proteins

Patient samples from Example 1 were evaluated using reverse-phase protein microarray (2470 Aushon Arrayer, Aushon Biosciences, Burlingham, Mass.) outfitted with 350 μm pins. The samples were spotted onto nitrocellulose-coated glass slides (Whatman, Inc, Sanford, Me.) in duplicate in five point dilution curves with approximately 4 μg total protein in the neat spot and 250 ng in the 1/16 spot. For estimation of total protein amounts, used to normalize all signals, selected arrays were stained with Sypro Ruby Protein Blot Stain (MOLECULAR PROBES, Invitrogen Corp., Carlsbad, Calif.) according to the manufacturer's instructions. One day before antibody staining, the lysate arrays were treated with Reblot antibody stripping solution (Chemicon International, Inc., Temecula, Calif.) and incubated for a minimum of 5 hours in blocking solution (1 g I-block (Tropix), 0.1% Tween-20 in 500 mL PBS). Blocked arrays were stained with antibodies on an automated slide stainer (Dako Corp., Carpinteria, Calif.) using the Catalyzed Signal Amplification System (CSA; Dako Corp., Carpinteria, Calif.) kit according to the manufacturer's recommendation.

The arrays were probed with antibodies (BD Transduction Laboratories, Franklin Lakes, N.J.) to 53 endpoints (See Table 1) chosen to specifically analyze the following signal pathways putatively involved in adipokine signaling and tissue changes: a) pro-survival/insulin-related signaling; b) pro-growth; c) inflammatory; d) apoptosis; e) cytokine and chemokine related.

TABLE 1

| | |
|---|---|
| Cleaved Caspase-3 (D175) | Phospho-EGFR (Y1068) |
| Cleaved Caspase-7 (D198) | Phospho-eIF4G (S1108) |
| Cleaved Caspase-9 (D315) | Phospho-eNOS (S1177) |
| Cleaved Caspase-9 (D330) | Phospho-eNOS/NOS III (S116) |
| COX2 | Phospho-ErbB2 (Y1248) |
| IRS-1 | Phospho-ERK (T202/Y204) |
| p70 S6 Kinase | Phospho-Estrogen Rec a (S118) |
| Phospho-4E-BP1 (S65) | Phospho-FADD (S194) |
| Phospho-AKT (S473) | Phospho-FAK (Y397) |
| Phospho-AKT (T308) | Phospho-FKHR (S256) |
| Phospho-AMPKalpha1 (S485) | Phospho-FKHR (T24)/FKHRL1 |
| | (T32) |
| Phospho-ASK1 (Ser83) | Phospho-GSK-3a/B (S21/9) |
| Phospho-BAD (S112) | Phospho-GSK3a/B (Y279/216) |
| Phospho-BAD (S136) | Phospho-IkappaB-alpha (S32) |
| Phospho-BAD (S155) | Phospho-IRS-1 (S612) |
| Phospho-c-Abl (Thr735) | Phospho-MARCKs (S152/156) |
| Phospho-c-Raf (S338) | Phospho-MEK1/2 (S217/221) |
| Phospho-CREB (S133) | Phospho-mTOR (S2448) |
| Phospho-p38 MAPK (T180/Y182) | Phospho-SAPK/JNK |
| | (T183/Y185) |
| Phospho-p70 S6 Kinase (T389) | Phospho-Shc (Y317) |
| Phospho-p90RSK (S380) | Phospho-SMAD2 (S465/467) |
| Phospho-PKA C (T197) | Phospho-Src (Y527) |
| Phospho-PKCa/B II (T638/641) | Phospho-Stat1 (Y701) |
| Phospho-PKCdelta (T505) | Phospho-Stat3 (S727) |
| Phospho-PTEN (S380) | Phospho-Stat5 (Y694) |
| Phospho-Pyk2 (Y402) | PI3-Kinase |
| Phospho-Ras-GRF1 (S916) | |

Stained slides were scanned individually on a UMAX PowerLook III scanner (UMAX, Dallas, Tex., USA) and analyzed with image analysis software (MICROVIGENE, version 2.200, VigeneTech, North Billerica, Mass.). The software performed spot finding, local background subtraction, replicate averaging and total protein normalization. A single value was generated for each sample at each endpoint. The values were then subjected to unsupervised hierarchical clustering analysis using JMP 5.0 (SAS Institute, Cary, N.C.). Parametric and non-parametric analysis was performed to compare the cell signaling networks of those with IR to those without IR. Additionally, analysis was performed on diabetic patients who resolved DM post-weight loss compared to those diabetic patients who continued to have DM despite weight loss.

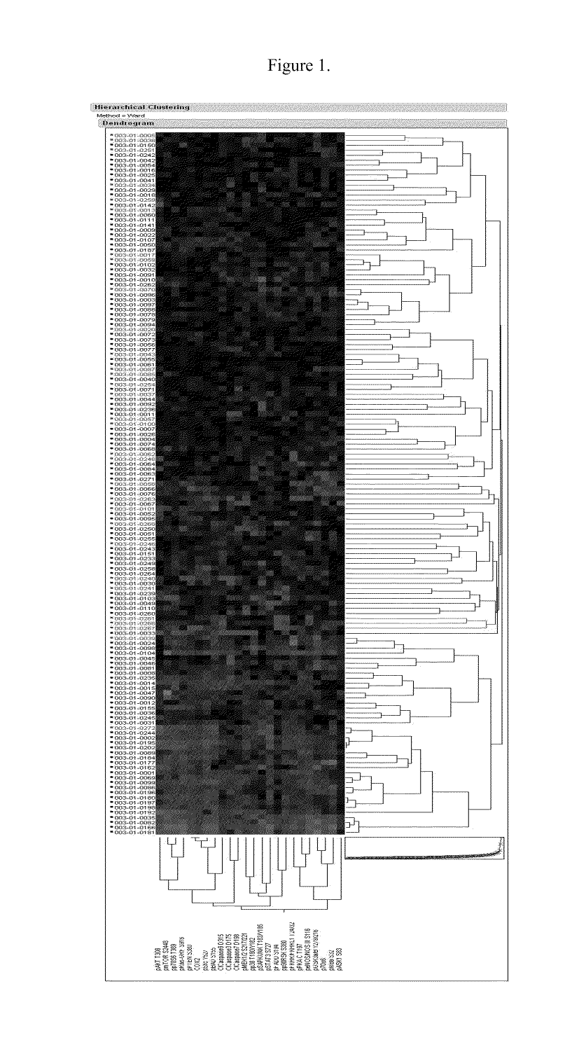

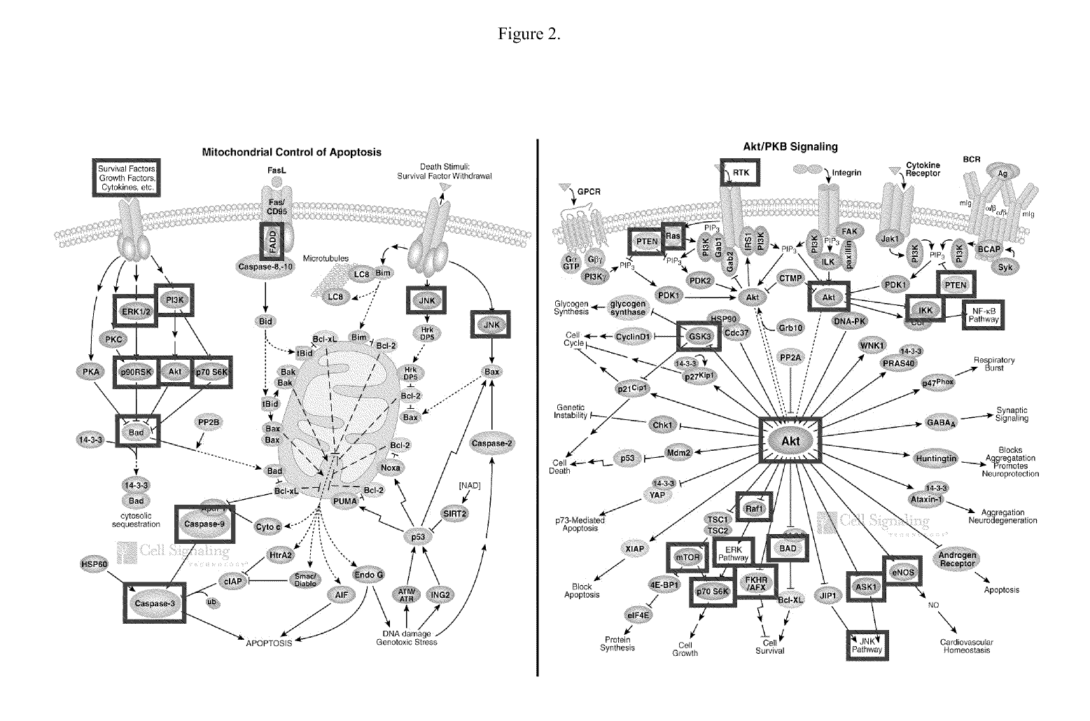

The results are shown in FIGS. 1-2 and Tables 2-4. Table 2 shows the statistically significant (p<0.05) phosphorylated signaling proteins elucidated in the indicated studies. Comparing 31 patients with overt DM to those without IR, the phosphorylation levels of proteins involved in insulin signaling, namely within the PI3K/mTOR pathway, such as AKT, GSK3B, p70S6K, ASK1, STAT3 and FKHRL were significantly different between the two groups (p<0.05). When comparing the 20 diabetics who had resolved their DM after weight loss to those 11 who did not, pSMAD2 S465/467 and pErbB2 Y1248 phosphoproteins were significantly (p<0.05) different between the two cohorts (Table 2).

TABLE 2

| | P-Value | P-Value |
|---|---|---|
| Sample | (T-Test) | (Wilcoxon) |
| Study: obese vs. | | |
| obese with DM | | |
| pAKT T308 | | 0.0395 |
| pMEK1/2 | | 0.0109 |
| S217/221 | | |
| pp38 T180/Y182 | | 0.0265 |
| pPTEN S380 | | 0.0062 |
| pmTOR S2448 | 0.0034 | |
| pRas-GRF S916 | | 0.0032 |
| pSAPK/JNK | | 0.0268 |
| T183/Y185 | | |
| pp70S6 T389 | | 0.0217 |
| ClCaspase3 D175 | | 0.0589 |
| ClCaspase7 D198 | | 0.0303 |
| ClCaspase9 D315 | | 0.0076 |
| pBAD S155 | | 0.0061 |
| pFADD S194 | | 0.0347 |
| pFKHR/FKHRL1 | | 0.0097 |
| T24/32 | | |
| pGSK3a/B | | 0.0424 |
| Y279/216 | | |
| pp90RSK S380 | | 0.0148 |
| pSrc Y527 | | 0.0048 |
| pSTAT3 S727 | | 0.019 |
| pIkBa S32 | | 0.0454 |
| p70s6 | | 0.0046 |
| pASK1 S83 | | 0.0139 |
| pPKA C T197 | | 0.0289 |
| peNOS/NOS III | | 0.0118 |
| S116 | | |
| COX2 | | 0.002 |
| Study: resolved vs. | | |
| non-resolved | | |
| pSMAD2 S465/467 | 0.01 | |
| pErbB2 Y1248 | 0.0447 | |

FIG. 1 shows a hierarchical clustering of the proteins in Table 2. Patients with DM are underlined. Phosphoendpoints are labeled on the x-axis. Segregation of 29/31 (94%) of the patients with DM is achieved using signaling endpoints that are contained within insulin/growth factor/AKT signaling and apoptosis control pathways.

FIG. 2 shows that nearly all of these proteins are associated with insulin or growth factor signaling. These results indicate that entire signaling networks within WAT are aberrantly changed in a coordinate fashion within patients with IR.

When comparing the median values of the phosphoproteins between the <50% EBW cohort and >50% EBW cohort, several proteins were significantly (p<0.05) different with regards to their level of phosphorylation between the two as shown below in Table 3. All of these endpoints were higher in those patients that lost the most weight.

TABLE 3

| | P-Value | P-Value |
|---|---|---|
| Sample | (T-test) | (Wilcoxon) |
| pAKT T308 | 0.0178 | |
| pmTOR S2448 | 0.0321 | |
| pRas-GRF S916 | | 0.0143 |
| pp70S6 T389 | | 0.0134 |
| ClCaspase3 D175 | | 0.0172 |
| pBAD S155 | | 0.0254 |
| pc-Abl T735 | | 0.0006 |
| pPyk2 Y402 | | 0.0121 |
| pp90RSK S380 | | 0.0047 |
| pPKCa/B II T638/641 | | 0.0584 |
| pSMAD2 S465/467 | | 0.0405 |
| pSrc Y527 | | 0.0224 |
| pBAD S112 | | 0.0167 |
| COX2 | | 0.0176 |

When comparing those patients whose waist size changed >50% to those subject whose waist size changed <50%, a number of statistically significant (p<0.05) phosphoproteins were found (See Table 4). All of these endpoints were higher in those patients that had >50% waist size change. These results indicate that signaling proteins in WAT can predict weight loss and point to new therapeutic targets in those patients who did not respond as well to therapy.

TABLE 4

| | P-Value | P-Value |
|---|---|---|
| Sample | (T-test) | (Wilcoxon) |
| pAKT S473 | | 0.0546 |
| pERK T202/Y204 | | 0.021 |
| pMEK1/2 S217/221 | | 0.0411 |
| pp38 T180/Y182 | | 0.0449 |
| pmTOR S2448 | 0.0067 | |
| pBAD S155 | | 0.0483 |
| peNOS S1177 | | 0.0204 |
| pFADD S194 | | 0.0357 |
| pPyk2 Y402 | | 0.0234 |
| pFKHR/FKHRL1 T24/32 | | 0.0427 |
| pGSK3a/B S21/9 | | 0.011 |
| pp90RSK S380 | | 0.0201 |
| pSTAT3 S727 | | 0.0031 |
| pCREB S133 | | 0.0244 |
| pBAD S112 | | 0.0016 |
| pERa S118 | | 0.0207 |
| pAMPKa1 S485 | | 0.0362 |

These results show that signal pathway profiling using reverse phase protein microarrays of WAT obtained at initial bariatric surgery appears to differentiate patients with DM from those without DM, and may be effective at predicting resolution of clinically overt DM and post weight loss surgery. Many of the phosphoprotein changes point to an overall pathway/network change within insulin and growth factor mediated signaling through the AKT/mTOR and ERK pathways.

### REFERENCES

1. Ong J P, Younossi Z M. Approach to the diagnosis and treatment of nonalcoholic fatty liver disease. Clin Liver Dis 2005; 9(4):617-34.
2. Neuschwander-Tetri B A. Nonalcoholic steatohepatitis and the metabolic syndrome. Am J Med Sci 2005; 330:326-335.
3. Ong J P, Elariny H, Collantes R, Younoszai A, Chandhoke V, Reines H D, Goodman Z, Younossi Z M. Predictors of nonalcoholic steatohepatitis and advanced fibrosis in morbidly obese patients. Obes Surg 2005; 15:310-315.
4. Calvert V S, Collantes R, Elariny H, Afendy A, Baranova A, Mendoza M, Goodman Z, Liotta L A, Petricoin E F, and Younossi Z M. A Systems Biology Approach to the Pathogenesis of Non-Alcoholic Fatty Liver Disease (NAFLD): Molecular Network Analysis of Human Adipose Tissue Can Distinguish Non-alcoholic Steatohepatitis (NASH) from Non-Progressive Simple Steatosis. Hepatology. 2007. Apr. 1
5. Matsuzawa Y. The metabolic syndrome and adipocytokines. FEBS Lett. 2006 May 22; 580(12):2917-21. Epub 2006 Apr. 21. Review.

We claim:

1. A method of assessing whether an obese patient with diabetes mellitus treated with a bariatric surgical procedure possesses a capacity to resolve the diabetes mellitus, the method comprising
a) obtaining a biological sample from said patient;
b) measuring in said sample the phosphorylation level of pSMAD2 S465/467 or pErbB2 Y1248; and
c) correlating said phosphorylation level to a capacity to resolve the diabetes mellitus.

2. The method of claim 1, wherein said sample is adipose tissue.

3. The method of claim 1, wherein said sample is white adipose tissue.

4. The method of claim 1, wherein said sample is omental fat or subcutaneous fat.

5. The method of claim 1, wherein said sample is obtained prior to undergoing bariatric surgery.

6. The method of claim 1, wherein said measuring comprises use of a reverse phase protein microarray.

7. The method of claim 1, wherein said measuring is conducted by detecting a phosphorylation-driven conformational change on electron transport.

8. The method of claim 1, wherein said resolution of diabetes comprises a reversal of impaired glucose tolerance, a return to a normal fasting glucose level or a return to a normal glycosylated hemoglobin level.

9. The method of claim 1, wherein said resolution is achieved without pharmaceutical intervention.

10. A method of estimating the likelihood of success of bariatric surgery for a patient, the method comprising
a) obtaining a biological sample from said patient;
b) measuring in said sample the phosphorylation level of a protein in Table 3 or Table 4; and
c) correlating said phosphorylation level to a likelihood that said patient will benefit from bariatric surgery.

11. The method of claim 10, wherein said sample is adipose tissue.

12. The method of claim 10, wherein said sample is white adipose tissue.

13. The method of claim 10, wherein said sample is omental fat or subcutaneous fat.

14. The method of claim 10, wherein said measuring step comprises measuring the phosphorylation level of a protein in Table 3 and said benefit is a reduction in excess body weight.

15. The method of claim 14, wherein said reduction is more than 50% excess body weight.

16. The method of claim 10, wherein said measuring step comprises measuring the phosphorylation level of a protein in Table 4 and said benefit is a reduction in waist size.

17. The method of claim 16, wherein said reduction is more than 50%.
